(19) United States
(12) Patent Application Publication
(10) Pub. No.: US 2003/0025719 A1
(43) Pub. Date: Feb. 6, 2003

(54) METHOD AND APPARATUS FOR INTERACTIVELY SELECTING, CONTROLLING AND DISPLAYING PARAMETERS FOR AN AVIONICS RADIO TUNING UNIT

(76) Inventors: GEORGE W. PALMER, CEDAR RAPIDS, IA (US); CLAUDE EYSSAUTIER, AIGREFEUILLE (FR); MATTHEW T. SMITH, MARION, IA (US)

Correspondence Address: ROCKWELL COLLINS INC, ATTENTION KYLE EPPELE, 400 COLLINS ROAD NE, CEDAR RAPIDS, IA, 52498

(21) Appl. No.: 09/391,781

(22) Filed: Sep. 8, 1999

(51) Int. Cl. G06F 3/00

(52) U.S. Cl. 345/700

(57) ABSTRACT

An apparatus and method for displaying, monitoring and controlling information relating to an avionics radio which includes use of a multi-functional display in front of the pilot incorporating a graphical user interface so as to result in a virtual radio tuning unit.

### BACKGROUND OF THE INVENTION

In the past, designers of avionics displays and flight deck electronic navigation, control and communication systems have endeavored to achieve a reduction in pilot workload. One area of concern has been the RTU, which typically requires a significant amount of “heads-down” time. This “heads-down” time occurs when the pilot is neither looking at the primary flight displays, nor out the wind screen, but instead is focused upon a task in an oblique direction, such as when using a typical RTU control unit, which may have an integrated keypad or tuning knob console and a mechanical or electronic textual display unit. One approach has been proposed in which a large stand-alone LCD display, disposed to the side of the pilot, is used for both viewing RTU information, as well as having the capability to provide data input through a graphical user interface and a cursor. While these stand-alone, side-mounted LCD RTUs have clear advantages, they also have significant drawbacks.

During times of heavy turbulence, otherwise very simple tasks can become too difficult and too time consuming. For example, the step of requiring a pilot to reposition the cursor to select from several options to display all of the RTU information may require an unacceptable period of time during times of heavy turbulence. Requiring the pilot to manually switch from COM 1 to COM 2 receivers each time he desires to view another, may be undesirable. Requiring the pilot to manipulate a knob or button to return to an immediately pre-existing view setting may also require too much attention during critical times. Requiring the pilot to turn her attention to a side mounted display may also be undesirable in certain circumstances. In general, during take-off and approach, the workload on a pilot can already be extreme, leaving the pilot with little or no time to spare. Any additional effort, at an already busy time, is quite undesirable.

Another continuous quest for avionics engineers is to develop enhancements which reduce the cost and the weight of avionics equipment. Prior art radio tuning units have been both relatively expensive and heavy. Typically, an RTU would include an electromechanical control panel with several mechanical dials and switches. These mechanical components must be engineered to achieve very high reliability. Consequently, they are frequently relatively expensive and heavy, thereby increasing fuel expenses and consuming precious potential revenue generating payload.

Consequently, there exists a need for improved methods and apparatuses for effecting the control of radio tuning units in an aircraft which overcome some of these shortcomings.

### SUMMARY OF THE INVENTION

It is an object of the present invention to provide an improved avionics display and RTU combination.

It is a feature of the present invention to include a forward mounted multi-functional display with RTU display capabilities.

It is another feature of the present invention to include a graphical user interface which allows for automatic expansion of a segment of an RTU display by selecting a menu key while a cursor is in the display segment.

It is yet another feature of the present invention to include an automatic time out feature which returns the RTU display to a pre-existing view.

It is still yet another feature of the present invention to include automatic cursor movement to appropriate fields on the RTU display upon manipulation of control unit buttons.

It is even another feature of the present invention to simultaneously display both COM 1 and COM 2 radio information in separate display segments.

It is an advantage of the present invention to reduce pilot workload.

It is another advantage of the present invention to enhance pilot situational awareness.

It is another feature of the present invention to include a virtual RTU.

It is another advantage of the present invention to eliminate the absolute requirement for a relatively heavy electromechanical RTU control panel.

The present invention is an apparatus and method for controlling an RTU on a display, which is designed to satisfy the aforementioned needs, provide the previously stated objects, include the above-listed features, and achieve the already articulated advantages. The present invention is carried out in a “heads down-less ” manner in a sense that the undesirable requirement for the pilot to turn her attention from the primary flight displays is reduced and concomitantly the cost and weight of such a RTU system is reduced.

Accordingly, the present invention is a combination of an RTU and an avionics display positioned and operating in innovative ways so as to reduce cost, weight, and pilot “heads down” time.

### BRIEF DESCRIPTION OF THE DRAWINGS

The invention may be more fully understood by reading the following description of the preferred embodiments of the invention, in conjunction with the appended drawing wherein:

FIG. 1 is a representation of a left side avionics display of the present invention, showing the display partitioned into segments including a single line RTU segment.

FIG. 2 is a representation of a right side avionics display of the present invention, showing the display partitioned into segments including a dual line RTU segment.

FIG. 3 is a representation of a secondary linked page of the present invention.

FIG. 4 is a representation of an avionics display of the present invention, showing the COM 1 display segment in an expanded state.

FIG. 5 is a representation of an avionics display of the present invention, showing the NAV 1 display segment in an expanded state.

FIG. 6 is a representation of an avionics display of the present invention, showing the HF 1 display segment in an expanded state.

FIG. 7 is a block diagram of an avionics system of the present invention.

### DETAILED DESCRIPTION

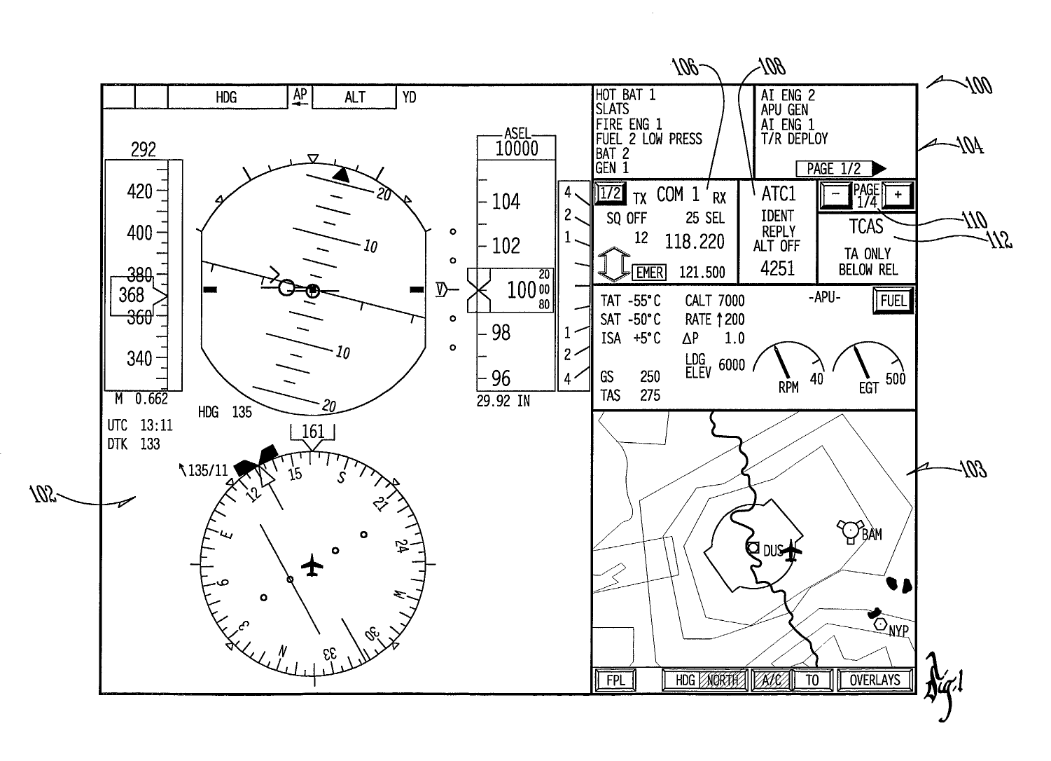

Now referring to the drawings wherein like numerals refer to like matter throughout, there is shown in FIG. 1 a left side display of the present invention, generally designated 100, having a primary flight display segment 102 and a second flight display segment 103. Second flight display segment 103 includes a one line RTU display segment 104, a COM 1 display segment 106, an ATC 1 display segment 108, a page selection display segment 110, and a TCAS display segment 112, as well as other non-RTU functions. The radio navigation, communication and control functions shown are dependent upon the equipment available on the aircraft and are configurable as desired.

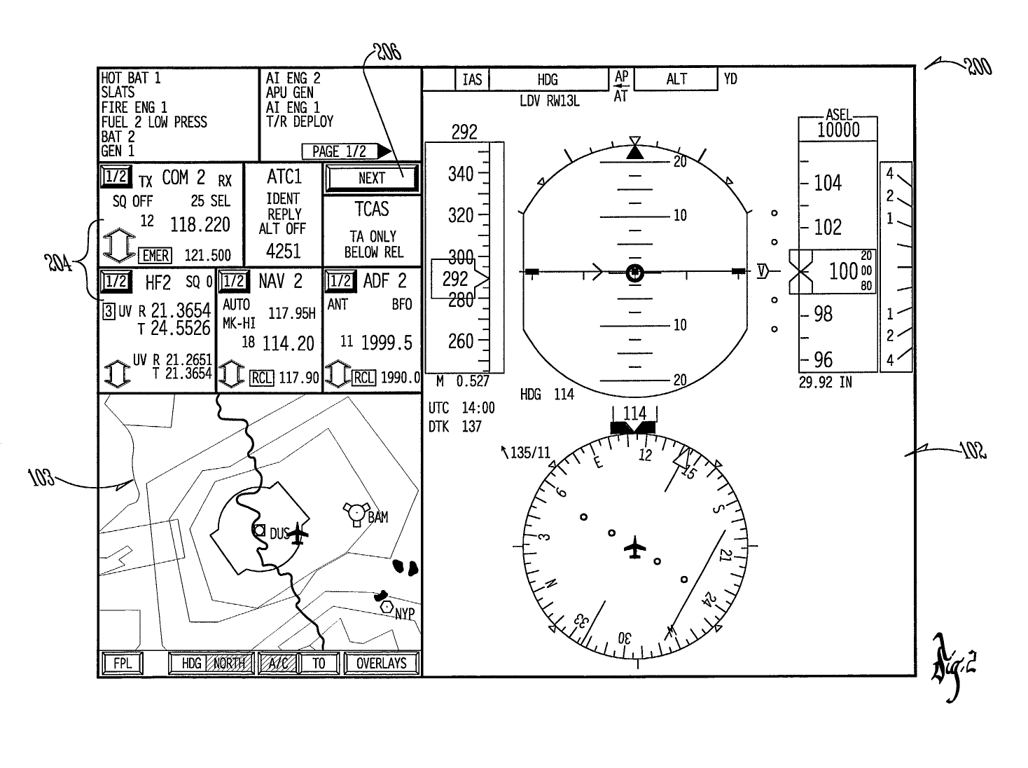

Now referring to FIG. 2, there is shown a right side display of the present invention, generally designated 200, including a primary flight display segment 102, a second flight display segment 103, and a two-line RTU display segment 204, as well as next page advancing button 206. The radio navigation, communication and control functions shown are dependent upon the equipment available on the aircraft and are configurable as desired.

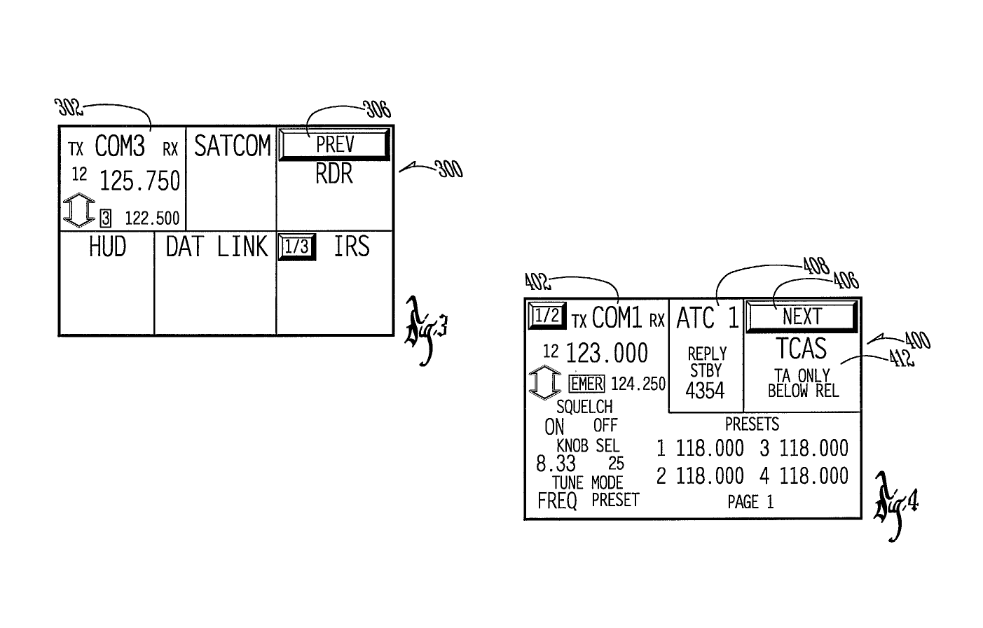

Now referring to FIG. 3, there is shown a secondary display page of the present invention, generally designated 300, including a COM 3 display segment 302 and a previous button 306. Page 300 represents a display which would be the result of clicking on next page advancing button 206 of FIG. 2 or page selection display segment 110 of FIG. 1. The radio navigation, communication and control functions shown are dependent upon the equipment available on the aircraft and are configurable as desired. Depending upon the designer's choice, there may be multiple ways to change pages on a display and to input a frequency change. Various combinations of known data entry methods could also be used, depending upon the particular requirements of any design. Additionally, it may be desirable to use a 1/2 page toggling button to facilitate rapid changes from COM 1 to COM 2 etc., especially if they are not shown simultaneously. A 1/2 toggle button is shown in the upper left-hand corner of FIG. 4.

The invention may use still other ways to navigate among the various possible pages. In one design, a menu button could be incorporated into a COM 1/2 display segment. With this menu button, you can activate a drop-down menu, with which you can select either a 1-row or 2-row RT display. Also, the display can now be configurable, so that with the drop-down menu, you can select COM 1/2/3, or HF 1/2 to be in this display segment.

Now referring to FIG. 4, there is shown a display page of the present invention, generally designated 400, which represents a two-line RTU display segment similar to the two line RTU display segment 204 of FIG. 2 (except it is configured to show COM 1) after the expanded COM 1 display segment 402 has been selected and expanded beyond its normal smaller window. The expansion is accomplished by moving the cursor into the unexpanded COM 1 area and pressing a menu button or otherwise generating any type of selection signal. The expanded COM 1 display segment 402 will, after a predetermined length of time after a selection has been made, or after a button has been manipulated, return to its smaller previous display size.

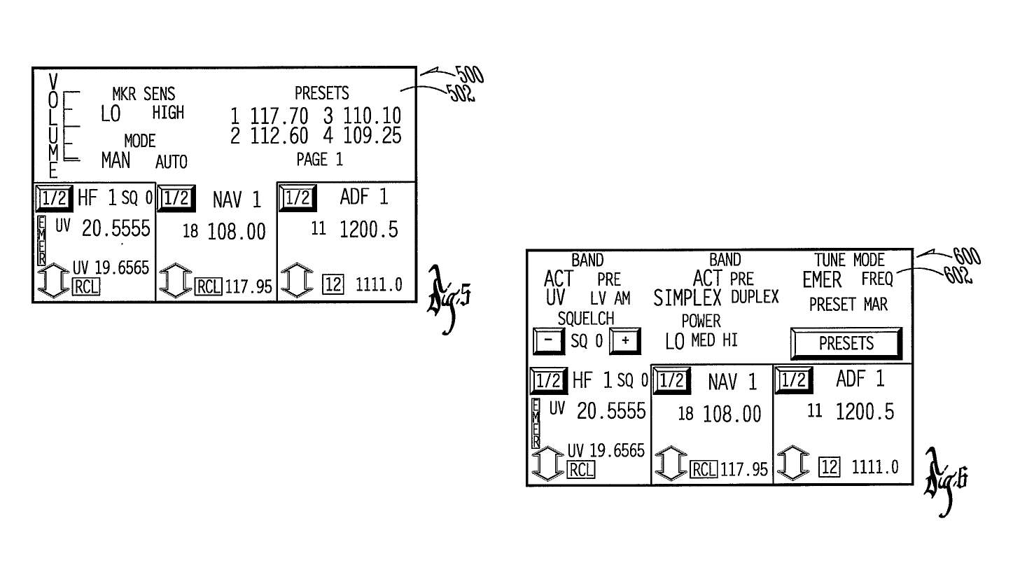

Now referring to FIG. 5, there is shown a display of the present invention generally designated 500, including an expanded NAV 1 display segment 502. Expanded NAV 1 display segment 502 is similar to expanded COM 1 display segment 402 of FIG. 4.

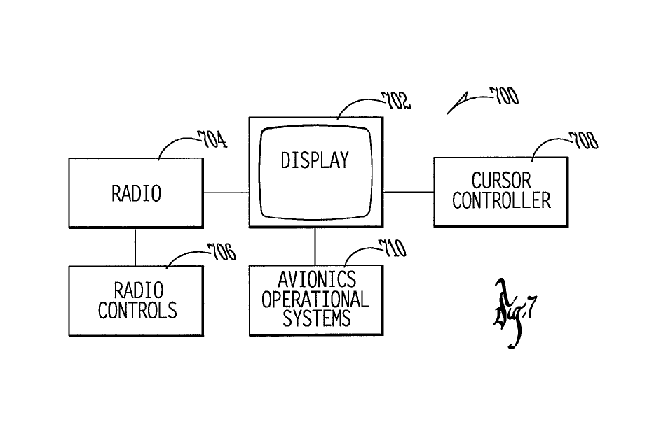

Now referring to FIG. 6, there is shown a display page of the present invention, generally designated 600, having an expanded HF 1 display segment 602. Expanded HF 1 display segment 602 is similar to expanded NAV 1 display segment 502 and expanded COM 1 display segment 402 of FIGS. 5 and 4 respectively.

Now referring to FIG. 7, there is shown an avionics system of the present invention, generally designated 700, including a display 702 coupled to an avionics radio 704 having radio controls 706, coupled thereto. A cursor control 708 is coupled to display 702. Preferably, display 702 is a multi-functional display disposed in front of the forward-looking pilot and is coupled to avionics systems 710, which are various systems for use by a pilot in control, communication and navigation. Display 702 receives display signals from avionics systems 710 for generating various displays, such as primary flight displays, weather radar, TCAS and any other display desired by a pilot. Radio 704 can be any type of navigation and/or communication radio for an aircraft.

In operation, the present invention functions as follows: a pilot can now control and monitor the function of navigation and communication radios on an aircraft by viewing a forward mounted display 702 and manipulating a cursor controller 708. When the pilot wishes to control the radio 704, she can use the graphical user interface (GUI), of the present invention, on the display 702. The GUI may include an RTU link on the display 702, or it may be activated by other actions, such as voice commands (which could be implemented by avionics operational systems 710), or manipulation of the radio controls 706. In a preferred embodiment, the GUI may be configured as shown in FIGS. 1-6; however, other configurations may be used as well. The term “operational” is used herein to describe aircraft navigational and/or aircraft control aspects of an aircraft which go beyond a mere navigation radio and a mere communication radio used for communicating control information.

Throughout this description, the terms “buttons” and “clicking” have been used. They are selected because they are believed to readily convey the present invention; however, it should be understood that other visual marks other than buttons could be substituted, and actions other than clicking could be substituted as well. It is intended that the present invention and the claims below be read to include all variations of these concepts.

The hardware and software to create the displays of the present invention are either well known in the art or could be adapted, without undue experimentation, from well-known hardware and software, by persons having ordinary skill in the art, once they have carefully reviewed the description of the present invention included herein.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

I claim:

1. An avionics system comprising:
an avionics radio receiver;
a display coupled to said avionics radio receiver;
an avionics operational system coupled to said display for providing information relating to operation of an aircraft to a pilot; and,
said display having a graphical user interface for generating commands to manipulate said avionics radio receiver in response to a signal generated in response to a positional characteristic of a cursor displayed on said display.

2. An avionics system of claim 1 wherein said avionics operational system is a navigation system.

3. An avionics system of claim 1 wherein said display is a multi-functional display disposed in front of a pilot.

4. An avionics system of claim 1 wherein said avionics radio receiver is a communication radio transceiver.

5. An avionics system of claim 1 wherein said graphical user interface returns a display shown on said display to a pre-existing display upon a passage of time.

6. An avionics display of claim 1 wherein said graphical user interface includes a simultaneous display of a COM 1 radio frequency of said avionics radio receiver and a COM 2 radio frequency of said avionics radio receiver.

7. An avionics system of claim 1 wherein said graphical user interface is coupled to a radio control, so that a predetermined manipulation of a radio control causes a cursor to move to a predetermined position of said display, wherein said predetermined position of said display provides information having a predetermined relationship with said predetermined manipulation of a radio control.

8. An avionics system of claim 1 wherein said graphical user interface provides an expanded view of a predetermined radio function when cursor is manipulated in a predetermined position on said display.

9. An avionics system comprising:
an avionics radio receiver;
a display coupled to said avionics radio receiver;
said display having a graphical user interface for generating commands to manipulate said avionics radio receiver in response to a signal generated in response to a positional characteristic of a cursor displayed on said display.

10. An avionics system of claim 9 wherein said graphical user interface returns a display shown on said display to a pre-existing display upon a passage of time.

11. An avionics display of claim 9 wherein said graphical user interface includes a simultaneous display of a COM 1 radio frequency of said avionics radio receiver and a COM 2 radio frequency of said avionics radio receiver.

12. An avionics system of claim 9 wherein said graphical user interface is coupled to a radio control, so that a predetermined manipulation of a radio control causes a cursor to move to a predetermined position of said display, wherein said predetermined position of said display provides information having a predetermined relationship with said predetermined manipulation of a radio control.

13. An avionics system of claim 9 wherein said graphical user interface provides an expanded view of a predetermined radio function when cursor is manipulated in a predetermined position on said display.

14. An avionics system comprising:
means for receiving radio signal on an aircraft;
means for displaying aircraft operational information to a pilot of an aircraft; and,
means for graphically coupling said means for receiving and said means for displaying.

15. An avionics system of claim 14 wherein said means for graphically coupling returns a pre-existing view to said means for displaying upon a passage of time.

16. An avionics system of claim 15 wherein said means for displaying simultaneously displays COM1 radio frequency information and COM 2 radio frequency information.

17. An avionics system of claim 16 wherein said means for graphically coupling is responsive to a manipulation of a control coupled to said means for receiving.

18. An avionics system of claim 17 wherein said means for graphically coupling expands a portion of said means for display so as to show additional information, in response to manipulating a cursor in a predetermined area of said means for displaying.

19. A method of tuning an aircraft radio comprising the steps of:
providing a multi-functional display; wherein said multi-functional display displays operational information;
providing an avionics radio receiver; and,
manipulating a cursor on said multi-functional display so as to control said avionics receiver.

20. A method of claim 19 further comprising the step of simultaneously displaying COM 1 and COM 2 radio frequency information on said multi-functional display.
